(19) United States
(12) Patent Application Publication
(10) Pub. No.: US 2012/0150446 A1
(43) Pub. Date: Jun. 14, 2012

(54) Interactive User Interface for Weather Data

(75) Inventors: Sidney Chang, Mountain View, CA (US); Lifu Tang, Beijing (CN)

(73) Assignee: Google Inc.

(21) Appl. No.: 13/096,119

(22) Filed: Apr. 28, 2011

Related U.S. Application Data
(63) Continuation of application No. PCT/CN2010/079655, filed on Dec. 10, 2010.

(51) Int. Cl. G06F 19/00

(52) U.S. Cl. 702/3

(57) ABSTRACT

In general, the subject matter described in this specification can be embodied in methods, systems, and program products for providing an interactive display of predictive weather data. A graphical interface includes a graph with predictive atmospheric temperature values and predictive values for a second weather statistic. Lateral user input over a display device is received. In response a position on the graph of a visible indication of a selected time is repeatedly changed to correspond to the lateral user input. The visible indication of the selected time includes a numerical display of the selected time that repeatedly updates as the position of the visible indication of the selected time changes. A numerical display of the atmospheric temperature value and a numerical display of the value for the second weather statistic repeatedly update to correspond to the selected time.

### CROSS-REFERENCE TO RELATED APPLICATION

This application claims benefit under 35 U.S.C. §120 of International Application No. PCT/CN2010/079655 having an International Filing Date of Dec. 10, 2010.

### TECHNICAL FIELD

This document generally relates to user interface displays of data.

### BACKGROUND

The internet and World Wide Web permits computer users to obtain all sorts of information to help them in their daily lives. For example, many users can check newspapers and receive other messages to keep them current with the news of the day. Also, users can get information about sports and other information of interest to them. Such information can be viewed via a browser application that loads and renders web pages or by way of specialized applications, or apps, that are dedicated to a particular task.

For example, users of computing devices can install application programs to view weather data, and can visit websites that display weather data. Such application programs and websites display weather forecasts for specific times in the future, for example, estimates of a high temperature for each of the next five days.

### SUMMARY

This document describes techniques, methods, systems, and mechanisms for providing an interactive user interface for displaying weather data. The user interface may display predictive information for each of at least two weather statistics plotted on the same graph. A graphical interface element may visually identify on the graph a time that has been selected. The individual may change the selected time by dragging the graphical interface element across the graph or by selecting a button that causes the graphical interface element to move across the graph.

The graphical interface element includes a numerical display of the selected time, and as the user interface element moves across the graph, the numerical display updates to show the time that is presently selected using the user interface element. Also, the user interface includes numerical displays of values for the at least two weather statistics. These values may update as the presently selected time changes. The values for the numerical displays for the weather statistics may update, but may remain fixed in location.

In general, one aspect of the subject matter described in this specification can be embodied in a computer-implemented method for providing an interactive display of predictive weather data. The method includes accessing a data set of predictive atmospheric temperature values for a time period, and a data set of predictive values of a second weather statistic for the time period. The method includes displaying, by a computing device and on a display device, a graphical interface. The graphical interface includes a graph with the data set of predictive atmospheric temperature values plotted to a first axis that corresponds to time and a second axis that corresponds to atmospheric temperature, and with the data set of predictive values for the second weather statistic plotted to the first axis that corresponds to time and a third axis that corresponds to the second weather statistic, the second and third axes being parallel to each other so that a line drawn perpendicular to the second axis intersects the third axis. The graphical interface includes a numerical display of a predictive atmospheric temperature value for a selected time and a numerical display of a predictive value for the second weather statistic for the selected time. The method includes receiving, by the computing device, lateral user input over a surface of the display device and the graphical interface. In response, a position on the graph of a visible indication of the selected time is repeatedly changed to correspond to the lateral user input, wherein the visible indication of the selected time includes a numerical display of the selected time that repeatedly updates as the position of the visible indication of the selected time changes. In response, the numerical display of the atmospheric temperature value and the numerical display of the value for the second weather statistic are repeatedly updated to correspond to the selected time.

Another aspect of the subject matter described in this specification can be embodied in a computer-readable storage medium storing instructions that, when executed by one or more processing devices, perform operations for providing an interactive display of predictive weather data. The operations include accessing a data set of predictive atmospheric temperature values for a time period, and a data set of predictive values of a second weather statistic for the time period. The operations include displaying, by the computing device and on a display device, a graphical interface. The graphical interface includes a graph that includes a plot of the data set of predictive atmospheric temperature values that intersects a plot of the data set of the second weather statistic, the graph having a first axis that corresponds to time and one or more other axes that correspond to atmospheric temperature and the second weather statistic. The graphical interface includes a numerical display of a predictive atmospheric temperature value for a selected time and a numerical display of a predictive value for the second weather statistic for the selected time. The operations include receiving, by the computing device, a user input that transitions across a display of the graphical interface. In response, a position on the graph of a visible indication of the selected time as the user input transitions across the display repeatedly changes. The visible indication includes a numerical display of the selected time that repeatedly updates to be consistent with a time that corresponds to the position of the visible indication of the selected time. In response, the numerical display of the atmospheric temperature value and the numerical display of the value for the second weather statistic repeatedly updates to correspond to the selected time as the user input transitions across the display.

In yet another aspect, the subject matter described in this specification can be embodied in a method for providing an interactive display of weather data. The method includes accessing a data set of atmospheric temperature values, and a data set of values of a second weather statistic. The method includes displaying, by a computing device and on a display, a graphical interface. The graphical interface includes a graph that includes a plot of the data set of atmospheric temperature values that overlaps with a plot of the data set of the second weather statistic. The graphical interface includes a numerical display of an atmospheric temperature value for a time selected by a user of the computing device and a numerical display of a value for the second weather statistic for the selected time. The method includes receiving, by the computing device, a user input that transitions across a display of the graphical interface. In response a position on the graph of a numerical display of the selected time repeatedly changes during the transitioning of the user input. The numerical display of the selected time repeatedly changes in time in coordination with the transitioning of the user input. In response the numerical display of the atmospheric temperature value and the numerical display of the value for the second weather statistic repeatedly updates to correspond to the selected time as the user input transitions across the display. The numerical display of the atmospheric temperature value and the numerical display of the value for the second weather statistic remain in fixed positions during the user input that transitions across the display of the graphical interface.

Particular embodiments can be implemented, in certain instances, to realize one or more of the following advantages. The user interface may visually illustrate on a single graph multiple weather trends over a period of time, while also showing particular data for a selected point in time. Thus, a user may be able to visually identify changes in weather over a time period, and how changes in a first weather statistic interact with changes in a second statistic. User selection of a particular point in time on the graph allows the user to view detailed numerical information for a time that is associated with the selected point. A numerical representation may appear at the particular point, informing a user of a time that has been selected. Thus, trends for multiple weather statistics, and information thereon, may be presented in a size-constrained display device.

The details of one or more embodiments are set forth in the accompanying drawings and the description below. Other features, objects, and advantages will be apparent from the description and drawings, and from the claims.

### DESCRIPTION OF DRAWINGS

FIG. 1 is an example display of an interactive user interface for displaying weather data.

FIGS. 2A-B are example displays of an interactive user interface for displaying weather data.

FIGS. 3A-B illustrate a flow chart for providing an interactive graphical interface for displaying weather data.

FIG. 4 is an example system for providing an interactive graphical interface for displaying weather data.

FIG. 5 is a conceptual diagram of a system that may be used to implement the systems and methods described in this document.

FIG. 6 is a block diagram of computing devices that may be used to implement the systems and methods described in this document, as either a client or as a server or plurality of servers.

Like reference symbols in the various drawings indicate like elements.

### DETAILED DESCRIPTION

This document generally describes the provision of an interactive user interface for weather data. The user interface may include two displayed portions. A first portion may present a graph of data sets for two or more weather statistics plotted over a time period. A second portion may display numerical values for each of the weather statistics for a time within the time period that has been selected.

A user may modify the time that has been selected by interacting with the user interface (e.g., by swiping a finger across a surface of the display or moving a mouse across a surface of the display). As an illustration, the user may touch his finger to the display at a location on the graph that corresponds to a particular time. As a result, the selected time may update to the particular time that has been selected, and a visual identifier may appear at the selected time. In various examples, the visual identifier includes a vertical line that bisects the plots of the at least two weather statistics. The visual identifier may also include a numerical display of the selected time or a display of an analog clock face with hour and minute hands positioned to represent the selected time.

In this illustration, the user may slide his finger across the display of the graph. As the user slides his finger across the graph, the vertical line and the numerical display of the selected time may move with his finger. The numerical display may repeatedly update to display the selected time, as the numerical display moves across the graph. Also, as the user slides his finger, the numerical values in the second displayed portion may repeatedly update to display weather statistic values that correspond to the repeatedly updating selected time, in coordination with the user's finger movement (e.g., as the finger moves to the right, values later in time are shown, and as the finger moves to the left, values earlier in time are shown).

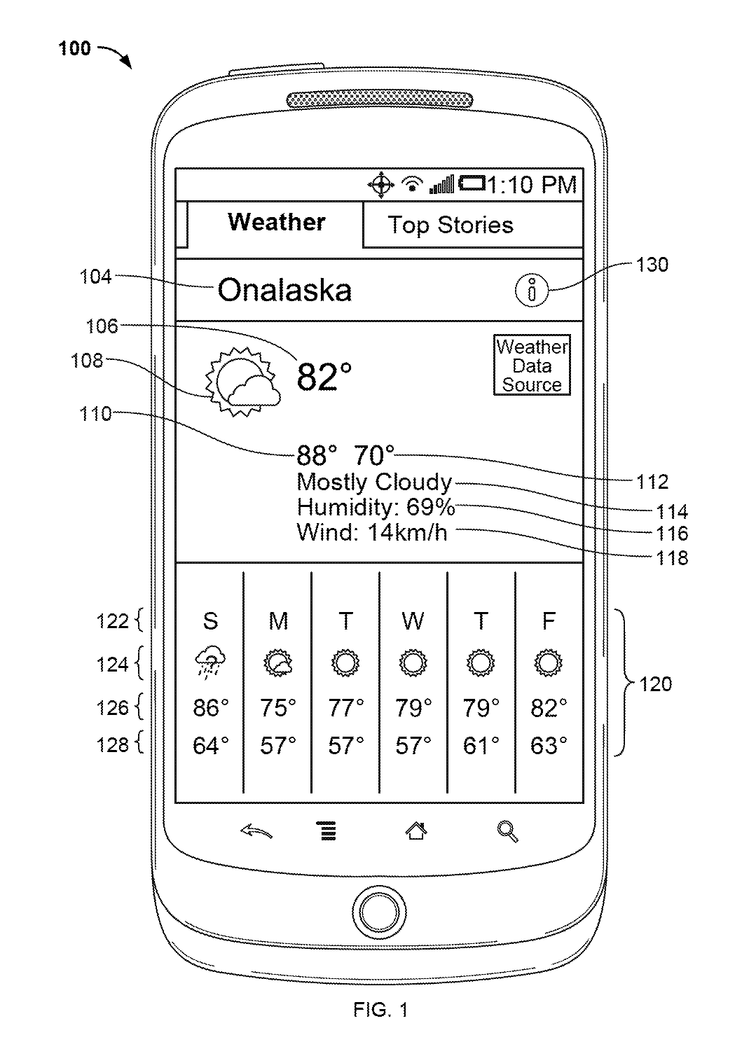

FIG. 1 is an example display of an interactive user interface for displaying weather data. In some examples, the user interface 100 is displayed by a computing device in response to user selection of an icon for launching an application program that displays weather data. In some examples, the user interface 100 is displayed by a web browser application program in response to a user requesting web browser navigation to a uniform resource locator (URL) that provides resources that cause a display of the user interface 100.

The user interface 100 displays a currently selected geographical location 104. The currently selected geographical location 104 may have been determined by the computing device without user input, for example, using signals from satellite-based navigational systems, triangulation of signals from base stations, or identification of a location of a base station transmitter. The currently selected location 104 may alternatively have been selected by the user. For example, the user may type Onalaska into a text box, selected an “enter” key, and in return receive the results “Onalaska, WI” and “Onalaska, TX.” The user may have selected the Wisconsin entry in order to set the currently selected location.

The user interface 100 also includes a current temperature 106, a graphical representation of a current state of weather 108, a high temperature for the present day 110, a low temperature for the present day 112, a textual representation of the present state of weather 114, a present humidity 116, and a present wind speed 118.

A bottom portion 120 of the user interface 100 displays weather data for each of multiple future days. In some examples, the weather data for each of the future days is a condensed form of the weather data that is presented for the current day. For example, the weather data for each future day may include: (i) an identification of the day 122, (ii) a graphical representation of the predicted state of weather 124, (iii) a predicted high temperature 126, and (iv) a predicted low temperature 128.

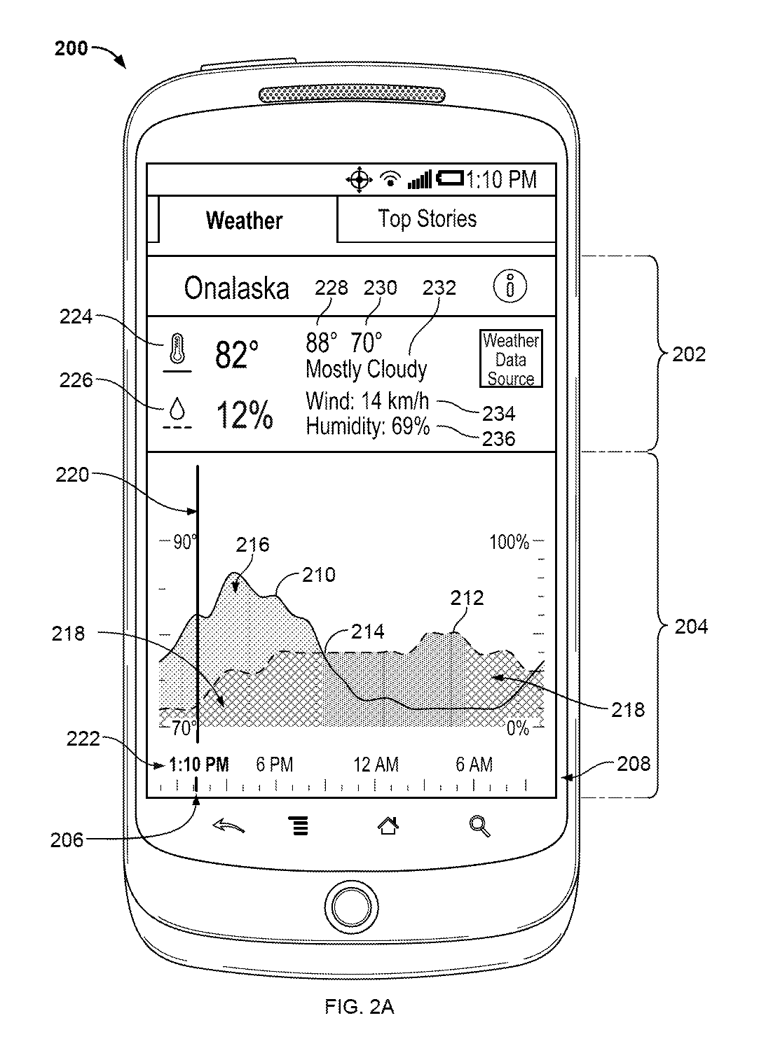

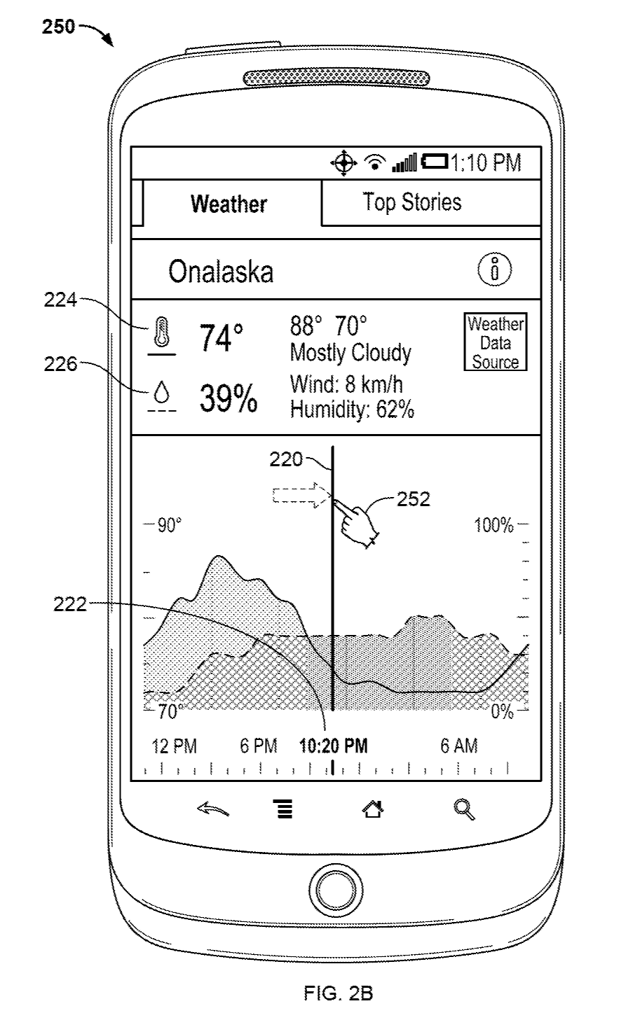

The user may select the “information” interface element 130 in order to view additional weather data. For example, upon user selection of the interface element 130, the graphical interface of FIG. 2 may be displayed.

FIGS. 2A-B are example displays of an interactive user interface for displaying weather data. The user interface 200 includes a top portion 202 and a bottom portion 204. The top portion 202 displays numerical values of weather statistics for a selected time (e.g., a display of Arabic numerals). The bottom portion 204 displays a graph that includes at least two weather statistics plotted across a range of times. The bottom portion also includes a visual identifier of the selected time 206. In this illustration, the visual identifier of the selected time 206 includes a vertical line 220 that denotes the selected time, and a numerical identifier of the selected time 222. A user may drag the visual identifier of the selected time 206 across the graph in order to change the selected time. In response to a change in the selected time, the numerical identifier of the selected time may update, and the numerical values of weather statistics that are displayed in the top portion may also update.

In greater detail, the bottom portion 204 includes a graph that has included therein plots of two data sets. In this illustration, the graph has plotted therein a temperature data set and a chance of precipitation data set. The temperature data set may be referred to herein as a “first” weather statistic, and a data set that accompanies the temperature data set may be referred to herein as a “second” weather statistic (or alternatively a “subsequent” or “alternative” weather statistic). Each dataset has been plotted over the same time period. In this illustration, the graph is a line graph. A line graph is a graph that displays discrete data points in a data set as connected by a line, or as approximated by a line. In some examples, the discrete data points are connected by straight line segments. In some examples, the discrete data points are connected or approximated by curved line segments. In this illustration, the visual indications of the discrete data points (e.g., dots scattered along and around the lines) are not displayed, however, the data points may be displayed in other implementations.

The data set of values that are used to generate the line graphs have been selected for the period of time. In some examples, the period of time is a present day. In some examples, the period of time includes the present time, a predetermined period of past time, and a predetermined period of future time. As an illustration, in FIG. 2A, the present time is 1:10 PM. The predetermined period of past time is two hours, rounded to the nearest hour. The predetermined period of future time is twenty hours, rounded to the nearest hour. Thus, the graph displays weather data starting at 11:00 AM and ending at 9 AM. In various examples, the period of time is determined to include the current time and a period of future time, but may not include past time.

The illustrated graph includes three axes. A horizontal x-axis is displayed at a bottom of the graph. The x-axis is scaled from a minimum value of 11 AM to a maximum value of 9 AM, with hash marks for every hour and fixed numerical identifiers of the hash mark for every six hours (e.g., the 12 PM, 6 PM, 12 AM, and 6 AM fixed numerical identifiers). Two vertical y-axes oppose each other at the vertical sides of the graph. A y-axis for temperature is displayed on the left of the graph and is scaled from a minimum value of 70 degrees to a maximum value of 90 degrees, with hash marks for every 5 degrees. A y-axis for percentage chance of precipitation is displayed on the right of the graph and is scaled from 0% chance of precipitation to 100% chance of precipitation.

A plot 210 of the data set for temperature values is displayed on the graph, where the plot values are indexed to the x-axis for time and the y-axis for temperature. A plot 212 of the data set for percentage chance of precipitation is also displayed on the same graph, where the plot values are indexed to the x-axis for time and the y-axis for percentage chance of precipitation.

The plot 210 and the plot 212 may be referenced as overlapping plots. The plots may be overlapping because plot 210 intersects plot 212 at the point of intersection 214. The plots may be overlapping because the y-axes for the plots oppose each other. In other words, a perpendicular line that is drawn through the y-axis for temperature perpendicularly intersects the y-axis for the percentage chance of precipitation. In another example, the plots may be overlapping because a line that is drawn perpendicular to both axes intersects each plot at least once.

Each plot may include different graphical characteristics. For example, plot 210 (temperature) may include a solid line while plot 212 (precipitation) may include a dashed line. In some examples, plot 210 includes a region of the graph that is filled with a first color scheme (e.g., the visual area 216), while plot 212 includes a region of the graph that is filled with a second color scheme (e.g., the visual area 218). Each visual area under a plot may represent probability of a given statistic occurring, for example, because the plot line may represent predicted maximum values for a timed period (and thus the shaded area may represent those probabilities under the maximum values). In various examples, each plot may include an additional plot line that corresponds to minimum values. In such examples, the shading may occur between, but not outside of, the maximum and minimum plot lines.

In this example, the plot 212 (precipitation) may appear in the “foreground” such that the color scheme for plot 212 at least partially obscures the color scheme for plot 210. A determination of which plot is in the foreground may be determined using various methods. For example, the plot that is in the foreground may be determined as a plot that begins a left edge of the graph with a lower value. The plot that is in the foreground may be determined as a plot that includes a smaller overall area under the plot. In some examples, a “working” hours portion of a plot (e.g., a portion that is between 9 AM and 5:30 PM) may have a different color scheme than a remaining portion of a plot. For example, the portion of the color scheme for plot 212 (precipitation) between the times 9 AM and 5:30 PM may be different than a remaining portion of the color scheme.

The bottom portion 204 of the user interface may include a visual identifier of the selected time 206. In this example, the visual identifier 206 includes a vertical line 220 that vertically bisects the graph. The vertical line 220 may intersect both plots, in some examples, each at a single point. A value of each plot at a point of intersection with the vertical line 220 may be a value of the data set for the plot at the selected time. In various examples, the value at the point of intersection lies between data set values, and is determined by an estimation algorithm.

The visual identifier 206 also includes a numerical display of the selected time 222. In this example, the numerical display of the selected time is displayed at a location that corresponds to the time 1:10 PM. In this example, the selected time may be a default time that is presented upon display of the graphical interface 200 (e.g., a default time that is presented without the user providing user input subsequent to an initial display of the user interface). In some examples, the default time may be a current time, or may be a current time rounded to a nearest increment (e.g., five or ten minute increment). In some examples, the default time may be the same for every display of the user interface (e.g., the default time may be noon upon invoking the user interface 200 for display, regardless of the time that the user interface 200 is invoked for display).

A user may provide user input to change the selected time. In some examples, the user may drag the vertical line 220 horizontally across the graph. For example, the user may press, on a touchscreen, a display of the line 220 or the numerical display 222 using his finger, and drag his finger across the touchscreen while the user keeps his finger in contact with the touchscreen. In some examples, the vertical line 220 may move with a mouse cursor, either by default or upon selection with a mouse button. In some examples, the user may not need to select the line 220 or the numerical display 222 in order to change the selected time. Instead, the user may be able to directly select a new time, for example, by tapping a different area of the graph. In some examples, the selected time corresponds to an x-axis position that has been selected by a user, even if the selected position does not lie on a plot. Thus, the user may touch a blank spot of the graph and the line 220 may move to intersect the selected position. In another example, the user may manipulate a mouse cursor over the display of the graph to change the selected time.

In various examples, user input controls are provided for manipulating a position of the vertical line 220 and the visual identification of the selected time 222. For example, the user interface 200 may include a slider control that is not overlaid with the graph. The slider control may be dragged in order to move the vertical line 220 to a corresponding position. Also, the user interface 200 may include forward and backward buttons that may be selected to cause the vertical bar 220 to slide forward or backward. In some examples, the graph does not include a vertical line 220. The graph may instead include a dot that moves along each of the plots 210 and 212 to identify a location of the presently selected time.

As described above, the numerical display 222 of the selected time may move with user input. For example, as the user drags the line 220 across the graph, the numerical display may move with the line 220. The numerical display 222 may move horizontally along a horizontal placement of fixed numerical identifiers for hash marks in the x-axis. Thus, at particular times, the numerical display 222 may overlap with fixed numerical identifiers, and the line 220 may overlap a hash mark. As the numerical display 222 moves, the numerical display 222 may repeatedly update to persistently display the selected time.

The top portion 202 includes multiple numerical values that are fixed in position, but that update as the selected time changes. In other words, as the user drags the vertical line 220 across the graph, the numbers in the top portion 202 of the user interface change. The dragging of the vertical line 220 may be substantially smooth, but the numerical identifier of the selected time 222 may update in fixed increments (e.g., every 10 minutes). The numerical values that are fixed in potion in the top portion 202 may update with a same frequency as the numerical identifier of the selected time 222.

More specifically, the selected time in FIG. 2A is shown as being 1:10 PM. At this time, the temperature is presently (or is predicted to be) 82 degrees (see fixed temperature identifier 224) and the chance of precipitation is estimated to be 12% (see identifier 226). These two weather statistics are prominently displayed in large text as they are the weather statistics that correspond to the data that is plotted in the graph.

The top portion 202 also includes ancillary weather statistics. The ancillary weather statistics also display numerical values that are fixed in position, but the numerical values may be smaller in size than the numerical values 224 and 226 for the primary weather statistics. Some of the ancillary weather statistics may change value as the selected time changes. Example ancillary weather statistics include a high temperature for the day 228 (fixed value), a low temperature for the day 230 (fixed value), a textual description of the state of weather 232 (content changes with selected time), a wind velocity 234 (value changes with selected time), and a humidity 236 (value changes with selected time). In some implementations, the high temperature 228 and low temperature 230 are for the displayed period of time.

In various examples, the “time” axis may be displayed as a vertical y-axis, and the “temperature” and “percentage chance of precipitation” may be displayed as horizontal x-axes. An axis may be represented, for example, by any combination of a plot line or plotted set of identifying symbols, a set of hash marks, and a set of numerical identifiers for hash marks. Each data point that is plotted on the graph may have an independent variable component (e.g., a “time” component) and a dependent variable component (e.g., a “temperature” or “chance of precipitation” component). In some examples, the axes for the dependent variables may be located on a same side of the graph. For example, a single set of hash marks may include a numerical identifier of temperature degrees on one side and a percentage chance of precipitation on the other side. Such a shared display of axes may illustrate “overlapping” axes.

In various examples, the graph displays a plot for a single weather statistic, or a plot for each of more than two weather statistics. In various examples, the user can add a weather data statistic to the graph by selecting a non-displayed statistic (e.g., humidity 236) and dragging the non-displayed statistic on to the graph. Similarly, a user may drag a statistic that is being displayed on the graph off of the graph. In various examples, a user may bring a plot to the forefront of the graph, for example, by tapping or double-tapping the plot or a colored region for the plot, or by selecting a numerical identifier for the plot (e.g., the numerical identifiers 224 or 226).

In various examples, the top portion 202 of the user interface does not overlap the bottom portion 204 of the user interface. Thus the numerical identifier in the top portion may not be located in the graph. In various examples, the numerical identifiers in the top portion 202 of the user interface that are fixed in position may be located in the graph, for example, in a portion of the graph that is free of the plots 210 and 212. In various examples, at least some of the numerical identifiers in the top portion 202 (e.g., the numerical identifiers 224, 226, 232, 234, and 236) move with the vertical line 220 (e.g., in a portion of the graph that is free of plots).

As described above, the plot for a data set may include a line that connects the data points in the data set, or that estimates the data points with a continuous line. Thus, a plot may visually identify intermediate values that are between two data points that have been explicitly defined by the data set. These intermediate values may be generated based on the explicitly defined data points.

As an illustration, as the user drags the line 220 across the user interface, the selected time 222 may regularly update. The selected time 222 may update in ten minute increments, but the data set for the weather statistic that is received from a weather service may only include data in thirty minute increments. Thus, the display of the line between each thirty minute increment, and the numerical values that are displayed in the top portion 202 between each thirty minute increment may be estimates that are determined based on the values in the data set. In various examples, the graph displays data in a different form. For example, the plot may include a bar graph or scatter plot representation of the data in a data set, and intermediate data points.

In various examples, the bottom portion 204 specifies a time period during which severe weather occurred, or is predicted to occur. As an illustration, a tornado warning or severe thunderstorm warning may be issued for the currently selected geographical location 104 for the time period of 2 pm to 3:30 pm. This portion of the graph may be shaded a different color or may be marked with a different pattern. The shaded or colored portion may appear as a vertical bar that extends the entire vertical height of the graph, or may appear as a region of the visual areas 216 and 218. Text within the display may identify a meaning of the shaded or colored portion of the graph. For example, text that is similarly shaded or colored may state “Hurricane warning.” The text may appear only upon the selected time being within the time period (e.g., when the user drags his finger over the shaded or colored region).

The user interface 250 of FIG. 2B illustrates the user interface 200 after a user has dragged the numerical display of the selected time 222 to a new selected time. For example, the icon of a hand 252 conceptually illustrates selection, on a touchscreen display device, of the line 220 and dragging of the line to the right. Accordingly, the line 220 has changed position, and the numerical display of the selected time 222 has updated to display time 10:20. The line 220 now intersects the plots at different locations, and the numerical values for temperature 224 and percentage chance of precipitation 226 have been updated to represent the numerical values of the plot at the points of intersection.

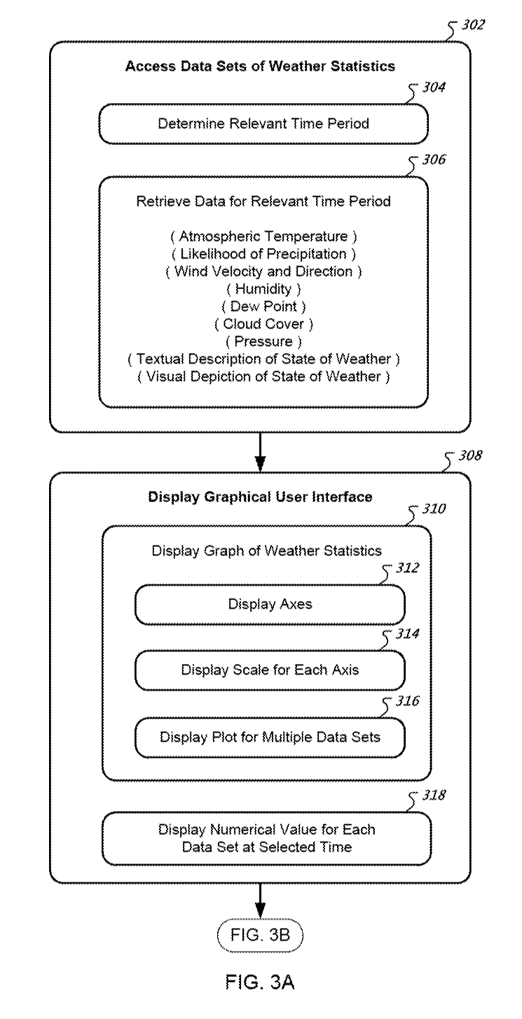

FIGS. 3A-3B illustrate a flow chart for providing an interactive graphical interface for displaying weather data. In box 302, data sets of weather statistics are accessed. For example, a computing device may receive, from a server system that hosts a weather data distribution service, data sets of weather statistics. Each data set may include multiple data values for a weather statistic, where each data value is associated with a corresponding time value. The data sets may be stored on the computing device.

In box 304, a relevant time period is determined. For example, a time period over which a graph is to display a plot for the weather statistic is determined as including a present time and times over a next twenty-four hours. In some examples, past time is also included in the time period. In some examples, the present time is not included in the time period, as the time period may only include times that are in the future.

In box 306, data is retrieved for the relevant time period. For example, a computing device may store data values for a weather statistic over a wide range of times. The computing device may select a subset of the data values that correspond to the relevant time period. In some examples, the computing device may send an indication of the relevant time period with a request to a server system for a data set of values. In response, the computing device may receive from the server system a data set that includes values for the relevant time period. Example types of weather statistics include atmospheric temperature, likelihood of precipitation, wind velocity and direction, humidity, dew point, wind chill, percentage of cloud cover, pressure, a textual description of a state of weather, and a visual depiction of a state of weather.

In box 308, a graphical user interface is displayed. The graphical user interface may be the interactive user interface that is illustrated in FIGS. 2A-2B.

In box 310, a graph of weather statistics is displayed in the user interface. Displaying the graph may include displaying the graph axes (box 312). Displaying the axes can include determining which weather statistics to display, and including an axis for each weather statistic, along with an axis for an independent variable that is shared among the weather statistics (e.g., a time axis). Thus, in some examples, the three axes may be time, atmospheric temperature, and likelihood of precipitation. Displaying the axes can also include determining a location at which to display each axis. For example the time axis can be displayed horizontally and the temperature and likelihood of precipitation axes can both be displayed horizontally.

Displaying the graph can include displaying a scale for each axis (box 314). The scale may be determined for a weather statistic based on a range of data values that were accessed for the relevant time period. For example, the scale may span at least the range of data values for the time period. The displayed scale can include hash marks that represent increments of the scale, and numbers that identify a value for at least some of the hash marks. The scale for each weather statistic may be different.

Displaying the graph can also include displaying a plot for each of multiple data sets (box 316). Displaying the plot for the data set can include visibly displaying for each data value a graphical marker that is indexed to the scales of the x and y axes. Displaying the plot can include displaying line segments that connect each of the plotted data values. Displaying the plot can include determining a function that approximates the data values, and graphing a continuous line that is indexed to the x-axis and y-axis and that represents the data set. Displaying the plot can include visibly displaying graphical markers along the continuous line, where the graphical markers may identify regular intervals of time and the associated value for the weather statistic.

At box 318, displaying the graphical user interface can include displaying a numerical value for each data set at a selected time. For example, a temperature value for a selected time may be displayed in a location that is exterior of the graph. Also, a value of a chance of precipitation for a selected time may be displayed in a location that is exterior of the graph. As described above, the selected time may default to a value upon initial display of the graphical user interface, and may be changed by a user.

In box 320, user input that changes the selected time is received. In some examples, the user input includes lateral movement across a surface of the graph (box 322). For example, a user may move his finger or a mouse cursor over the display of the graph, and the selected time may repeatedly update to correspond to an x-axis location of the finger or the mouse cursor. In some examples, the user input includes lateral movement outside of the graph (box 324). For example, the user may interact with a user interface control that causes adjustment of the selected time. Example user interface controls may include a slider, up and down buttons, a dial, and a keyboard for entering a specific time.

In box 326, the graphical user interface is updated in response to the received user input. For example, an interface element on the graph that identifies the selected time is repeatedly updated (box 328). The interface element may numerically display the selected time (box 330) and may graphically identify the selected time based on the position of the interface element on the graph (box 332). Thus, as the selected time changes, the position and numerical value of the interface element may change. For example, the position of the line 220 and the value of the numerical identifier of the selected time 222 may update as user input is received changing the value of the selected time.

In box 334, a numerical value that represents a value of a data set at a selected time is repeatedly updated as the selected time changes. For example, the numerical identifiers 224 and 226 may remain in a fixed position but may update as the selected time changes.

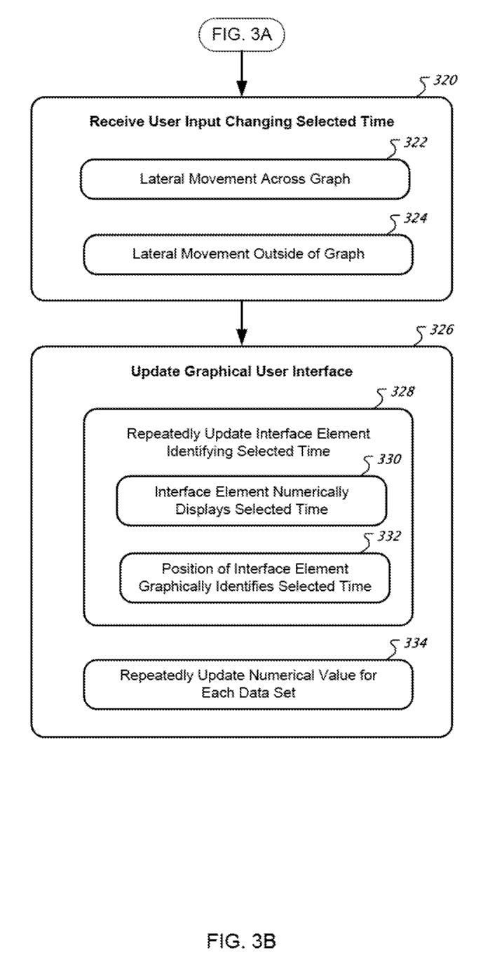

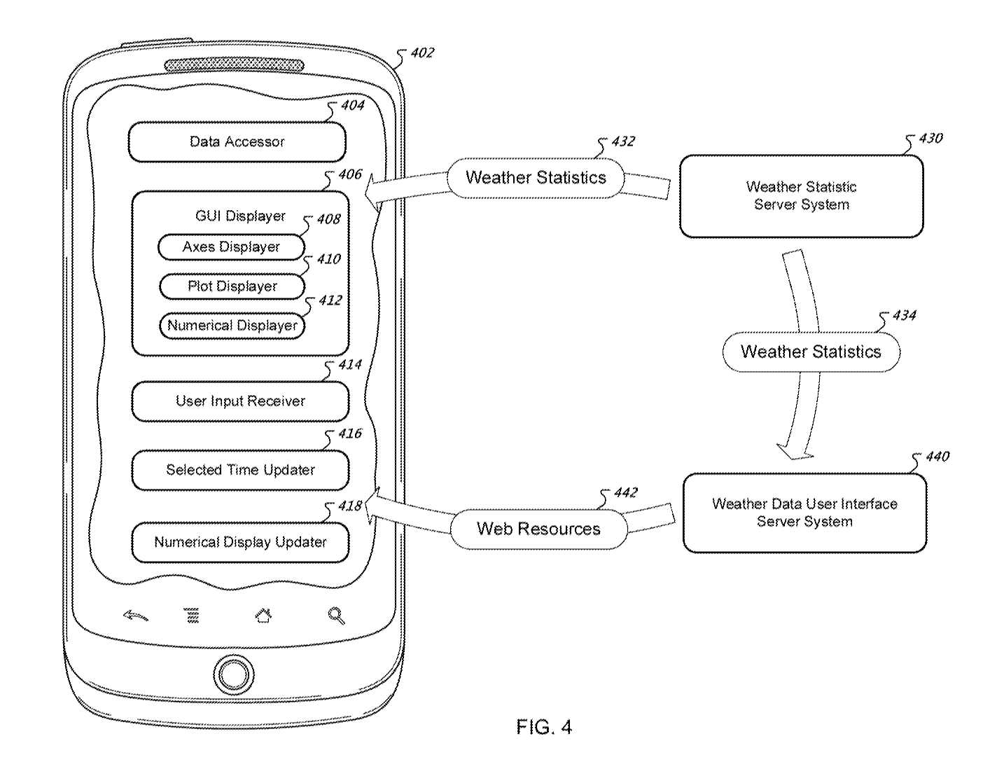

FIG. 4 is an example system for providing an interactive graphical interface for displaying weather data. The system may include a weather statistic server system 430 that collects weather statistics and transmits the weather statistics to either the computing device 402, or the weather data user interface server system 440, which sends to the computing device 402 web resources 442 for generating the user interface.

In greater detail, the weather statistic server system 430 stores weather data statistics. In some examples, the server system 430 aggregates the data from other sources (e.g., from multiple government-provided sources) to form a comprehensive database of weather statistics. Such data may be organized in a variety of manners and particular fields of data may be related to each other in a manner that permits easy retrieval and display of the data. Particular keys around which the data may be organized include geographical locations (e.g., for particular zip codes or other area identifiers) and times (e.g., so that predicted temperatures are stored for each hour of a coming day). The server system 430 may provide weather statistics 432 to the computing device 402 on a periodic subscription basis, or in response to a request for the weather statistics 432.

For example, the data accessor 404 may determine a time period for which the computing device 402 would like to present weather data. The data accessor 404 may send a request to the server system, where the request identifies a type of weather statistic and the relevant time period for which to obtain to the weather statistic. The computing device 402 may receive weather statistics 432 in response to the request.

GUI displayer 406 may receive statistical data sets from the data accessor 404 and may generate an interactive graphical user interface for displaying a representation of the data to a user. For example, the GUI displayer 406 may generate the user interface that is displayed in FIGS. 2A-B by performing the operations of box 308. Accordingly, an axes displayer 408 may perform the operations of boxes 312 and 314 in order to identify and display a set of axes for a graph. A plot displayer 410 may perform the operations of box 316 in order to generate and display a plot for each of multiple data sets. A numerical displayer 412 may perform the operations of box 318 in order to display a numerical value for each data set at a time that has been selected.

The computing device 402 includes a user input receiver 414. The user input receiver 414 identifies user input, determines if the user input is for changing a selected time, and if so, changes the selected time. For example, the user input receiver 414 may determine if the computing device 402 is receiving user input that identifies a location on the display that is bounded by the axes of a displayed graph. If so, the user input receiver 414 may identify a time value that corresponds to the identified location, and may change the selected time to the identified time value. In some examples, the user input receiver 414 identifies if user input has activated a control for changing the selected time, and if so, changes the selected time.

The selected time updater 416 may receive indications of changes to the selected time, and in response may update a displayed indication of the selected time, for example, by performing the operations of box 328. For example, the selected time updater 416 may update a numerical display of the value for the selected time on an interface element that numerically displays the selected time, and may change a position of the interface element.

The numerical display updater 418 may receive indications of changes to the selected time, and in response may update a numerical value of an interface element that numerically displays a value for the selected time. The interface element that numerically displays the value may be fixed in position as the numerical value changes. For example, the numerical display updater 416 may change a value of a temperature interface element 224 and a chance of precipitation interface element 226.

In various examples, the data accessor 404, the GUI displayer 406, the user input receiver 414, the selected time updater 416, and the numerical display updater 418 were installed at the computing device 402 as components of an application program that a user downloaded from an application store. The described components, as received from the application store, may not include specific weather statistics, and thus weather statistics 432 may need to be retrieved from the weather statistic server system 430 every time new weather data is to be displayed.

In some examples, the data accessor 404, the GUI displayer 406, the user input receiver 414, the selected time updater 416, and the numerical display updater 418 are received at the computing device 402 as components in a collection of web resources 442. The web resources 442 may be received at the computing device 402 in response to a web browser submitting a request for resources. The request may be directed to a URL address that corresponds to the weather data user interface server system 440. Thus, the referenced components may collectively make up a web application program that is executed by a web browser.

As an illustration, a user of the computing device 402 may open a web browser application program and select a bookmark. In response, the web browser may send, over the internet and to a server system identified by a URL in the bookmark, a request for resources. The weather data user interface server system 440 may receive the request. In response, the weather data user interface server system 440 may provide the referenced components to the mobile computing device for execution by a web browser.

In various examples, the referenced components, as received by the computing device 402, are configured to present particular data values for a determined time period. In such examples, the mobile computing device may need not request weather statistics 432 from the server system 430. In some examples, the referenced components are generic components that can present illustrations of weather statistics for a variety of time periods (but may not include data on weather statistics). In these examples, the referenced components may need to request weather statistics 432 from the weather statistic server system 430. Accordingly, the data accessor 404, the GUI displayer 406, the user input receiver 414, the selected time updater 416, and the numerical display updater 418 may be located at the computing device 402, the weather data user interface generator server system 440, or split among the two computing systems (e.g., where operations are performed in part by the mobile device 402 and in part by the server system 440 in a client-server relationship).

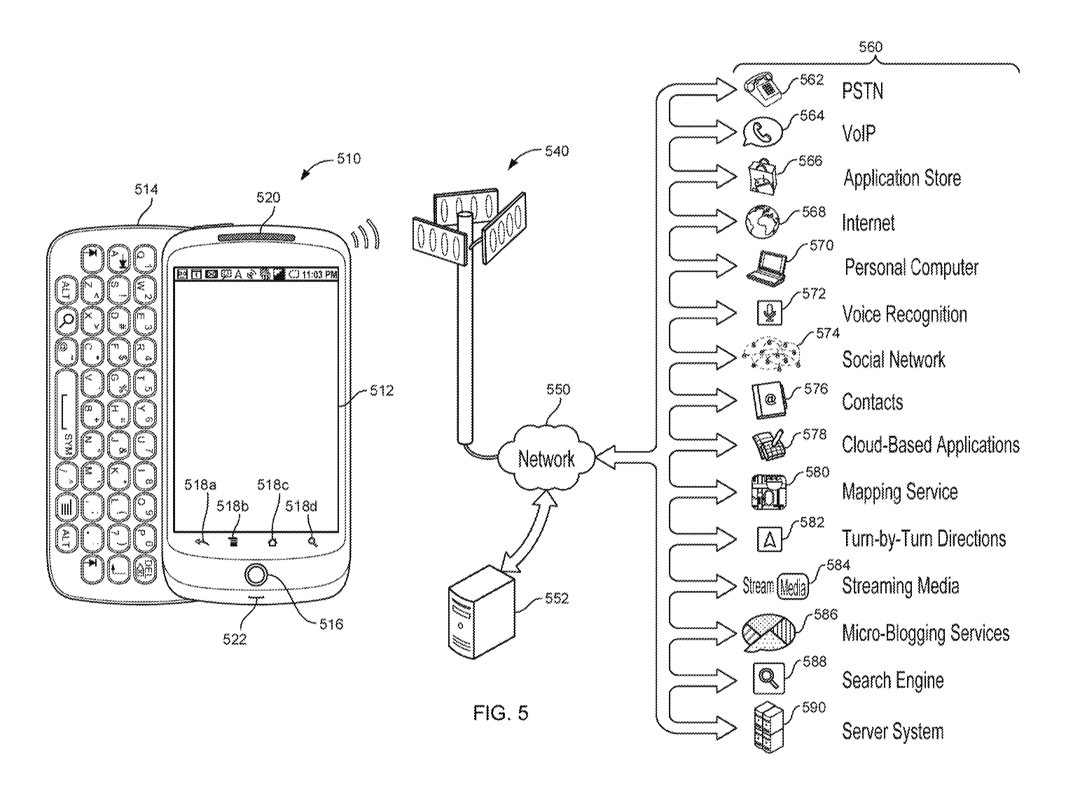

Referring now to FIG. 5, a conceptual diagram of a system that may be used to implement the systems and methods described in this document is illustrated. In the system, mobile computing device 510 can wirelessly communicate with base station 540, which can provide the mobile computing device wireless access to numerous hosted services 560 through a network 550.

In this illustration, the mobile computing device 510 is depicted as a handheld mobile telephone (e.g., a smartphone, or application telephone) that includes a touchscreen display device 512 for presenting content to a user of the mobile computing device 510 and receiving touch-based user inputs. Other visual, auditory, and tactile output components may also be provided (e.g., LED lights, a speaker for providing tonal, voice-generated, or recorded output, or vibrating mechanisms for tactile output), as may various different input components (e.g., keyboard 514, physical buttons, trackballs, accelerometers, gyroscopes, and magnetometers).

Example visual output mechanism in the form of display device 512 may take the form of a 3.7 or 4.3 inch LED or AMOLED display with resistive or capacitive touch capabilities, for displaying video, graphics, images, and text, and coordinating user touch inputs locationally with the displayed information so that user contact above a displayed item may be associated with the item by the device 510. The mobile computing device 510 may take alternative forms also, including as a laptop computer, a tablet or slate computer, a personal digital assistant, an embedded system (e.g., a car navigation system), a desktop personal computer, or a computerized workstation.

An example mechanism for receiving user-input includes keyboard 514, which may be a full qwerty keyboard or a traditional keypad that includes keys for the digits ‘0-9’, ‘*’ and ‘#.’ The keyboard 514 receives input when a user physically contacts or depresses a keyboard key. User manipulation of a trackball 516 or interaction with a trackpad enables the user to supply directional and rate of rotation information to the mobile computing device 510 (e.g., to manipulate a position of a cursor on the display device 512).

The mobile computing device 510 may be able to determine a position of physical contact with the touchscreen display device 512 (e.g., a position of contact by a finger or a stylus). Using the touchscreen 512, various “virtual” input mechanisms may be produced, where a user interacts with a graphical user interface element depicted on the touchscreen 512 by contacting the graphical user interface element. An example of a “virtual” input mechanism is a “software keyboard,” where a keyboard is displayed on the touchscreen and a user selects keys by pressing a region of the touchscreen 512 that corresponds to each key.

The mobile computing device 510 may include mechanical or touch sensitive buttons 518a-d. Additionally, the mobile computing device may include buttons for adjusting volume output by the one or more speakers 520, and a button for turning the mobile computing device on or off. A microphone 522 allows the mobile computing device 510 to convert audible sounds into an electrical signal that may be digitally encoded and stored in computer-readable memory, or transmitted to another computing device. The mobile computing device 510 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. Example operating systems include the ANDROID mobile device platform; APPLE IPHONE/MAC OS X operating systems; MICROSOFT WINDOWS 7/WINDOWS MOBILE operating systems; SYMBIAN operating system; RIM BLACKBERRY operating system; PALM WEB operating system; a variety of UNIX-flavored operating systems; or a proprietary operating system for computerized devices. The operating system may provide a platform for the execution of application programs that facilitate interaction between the computing device and a user.

The mobile computing device 510 may present a graphical user interface with the touchscreen 512. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 504. User-selection of the button may invoke the pre-defined action.

In some examples, the operating system provides a “desktop” user interface that is displayed upon turning on the mobile computing device 510, activating the mobile computing device 510 from a sleep state, upon “unlocking” the mobile computing device 510, or upon receiving user-selection of the “home” button 518c. The desktop graphical interface may display several icons that, when selected with user-input, invoke corresponding application programs. An invoked application program may present a graphical interface that replaces the desktop graphical interface until the application program terminates or is hidden from view.

User-input may manipulate a sequence of mobile computing device 510 operations. For example, a single-action user input (e.g., a single tap of the touchscreen, swipe across the touchscreen, contact with a button, or combination of these at a same time) may invoke an operation that changes a display of the user interface. Without the user-input, the user interface may not have changed at a particular time. For example, a multi-touch user input with the touchscreen 512 may invoke a mapping application to “zoom-in” on a location, even though the mapping application may have by default zoomed-in after several seconds.

The desktop graphical interface can also display “widgets.” A widget is one or more graphical interface elements that are associated with an application program that has been executed, and that display on the desktop content controlled by the executing application program. A widget's application program may start with the mobile telephone. Further, a widget may not take focus of the full display. Instead, a widget may only “own” a small portion of the desktop, displaying content and receiving touchscreen user-input within the portion of the desktop.

The mobile computing device 510 may include one or more location-identification mechanisms. A location-identification mechanism may include a collection of hardware and software that provides the operating system and application programs an estimate of the mobile telephone's geographical position. A location-identification mechanism may employ satellite-based positioning techniques, base station transmitting antenna identification, multiple base station triangulation, internet access point IP location determinations, inferential identification of a user's position based on search engine queries, and user-supplied identification of location (e.g., by “checking in” to a location).

The mobile computing device 510 may include other application modules and hardware. A call handling unit may receive an indication of an incoming telephone call and provide a user capabilities to answer the incoming telephone call. A media player may allow a user to listen to music or play movies that are stored in local memory of the mobile computing device 510. The mobile telephone 510 may include a digital camera sensor, and corresponding image and video capture and editing software. An internet browser may enable the user to view content from a web page by typing in an addresses corresponding to the web page or selecting a link to the web page.

The mobile computing device 510 may include an antenna to wirelessly communicate information with the base station 540. The base station 540 may be one of many base stations in a collection of base stations (e.g., a mobile telephone cellular network) that enables the mobile computing device 510 to maintain communication with a network 550 as the mobile computing device is geographically moved. The computing device 510 may alternatively or additionally communicate with the network 550 through a Wi-Fi router or a wired connection (e.g., Ethernet, USB, or FIREWIRE). The computing device 510 may also wirelessly communicate with other computing devices using BLUETOOTH protocols, or may employ an ad-hoc wireless network.

A service provider that operates the network of base stations may connect the mobile computing device 510 to the network 550 to enable communication between the mobile computing device 510 and other computerized devices that provide services 560. Although the services 560 may be provided over different networks (e.g., the service provider's internal network, the Public Switched Telephone Network, and the Internet), network 550 is illustrated as a single network. The service provider may operate a server system 552 that routes information packets and voice data between the mobile computing device 510 and computing devices associated with the services 560.

The network 550 may connect the mobile computing device 510 to the Public Switched Telephone Network (PSTN) 562 in order to establish voice or fax communication between the mobile computing device 510 and another computing device. For example, the service provider server system 552 may receive an indication from the PSTN 562 of an incoming call for the mobile computing device 510. Conversely, the mobile computing device 510 may send a communication to the service provider server system 552 initiating a telephone call with a telephone number that is associated with a device accessible through the PSTN 562.

The network 550 may connect the mobile computing device 510 with a Voice over Internet Protocol (VoIP) service 564 that routes voice communications over an IP network, as opposed to the PSTN. For example, a user of the mobile computing device 510 may invoke a VoIP application and initiate a call using the program. The service provider server system 552 may forward voice data from the call to a VoIP service, which may route the call over the internet to a corresponding computing device, potentially using the PSTN for a final leg of the connection.

An application store 566 may provide a user of the mobile computing device 510 the ability to browse a list of remotely stored application programs that the user may download over the network 550 and install on the mobile computing device 510. The application store 566 may serve as a repository of applications developed by third-party application developers. An application program that is installed on the mobile computing device 510 may be able to communicate over the network 550 with server systems that are designated for the application program. For example, a VoIP application program may be downloaded from the Application Store 566, enabling the user to communicate with the VoIP service 564.

The mobile computing device 510 may access content on the internet 568 through network 550. For example, a user of the mobile computing device 510 may invoke a web browser application that requests data from remote computing devices that are accessible at designated universal resource locations. In various examples, some of the services 560 are accessible over the internet.

The mobile computing device may communicate with a personal computer 570. For example, the personal computer 570 may be the home computer for a user of the mobile computing device 510. Thus, the user may be able to stream media from his personal computer 570. The user may also view the file structure of his personal computer 570, and transmit selected documents between the computerized devices.

A voice recognition service 572 may receive voice communication data recorded with the mobile computing device's microphone 522, and translate the voice communication into corresponding textual data. In some examples, the translated text is provided to a search engine as a web query, and responsive search engine search results are transmitted to the mobile computing device 510.

The mobile computing device 510 may communicate with a social network 574. The social network may include numerous members, some of which have agreed to be related as acquaintances. Application programs on the mobile computing device 510 may access the social network 574 to retrieve information based on the acquaintances of the user of the mobile computing device. For example, an “address book” application program may retrieve telephone numbers for the user's acquaintances. In various examples, content may be delivered to the mobile computing device 510 based on social network distances from the user to other members. For example, advertisement and news article content may be selected for the user based on a level of interaction with such content by members that are “close” to the user (e.g., members that are “friends” or “friends of friends”).

The mobile computing device 510 may access a personal set of contacts 576 through network 550. Each contact may identify an individual and include information about that individual (e.g., a phone number, an email address, and a birthday). Because the set of contacts is hosted remotely to the mobile computing device 510, the user may access and maintain the contacts 576 across several devices as a common set of contacts.

The mobile computing device 510 may access cloud-based application programs 578. Cloud-computing provides application programs (e.g., a word processor or an email program) that are hosted remotely from the mobile computing device 510, and may be accessed by the device 510 using a web browser or a dedicated program. Example cloud-based application programs include GOOGLE DOCS word processor and spreadsheet service, GOOGLE GMAIL webmail service, and PICASA picture manager.

Mapping service 580 can provide the mobile computing device 510 with street maps, route planning information, and satellite images. An example mapping service is GOOGLE MAPS. The mapping service 580 may also receive queries and return location-specific results. For example, the mobile computing device 510 may send an estimated location of the mobile computing device and a user-entered query for “pizza places” to the mapping service 580. The mapping service 580 may return a street map with “markers” superimposed on the map that identify geographical locations of nearby “pizza places.”

Turn-by-turn service 582 may provide the mobile computing device 510 with turn-by-turn directions to a user-supplied destination. For example, the turn-by-turn service 582 may stream to device 510 a street-level view of an estimated location of the device, along with data for providing audio commands and superimposing arrows that direct a user of the device 510 to the destination.

Various forms of streaming media 584 may be requested by the mobile computing device 510. For example, computing device 510 may request a stream for a pre-recorded video file, a live television program, or a live radio program. Example services that provide streaming media include YOUTUBE and PANDORA.

A micro-blogging service 586 may receive from the mobile computing device 510 a user-input post that does not identify recipients of the post. The micro-blogging service 586 may disseminate the post to other members of the micro-blogging service 586 that agreed to subscribe to the user.

A search engine 588 may receive user-entered textual or verbal queries from the mobile computing device 510, determine a set of internet-accessible documents that are responsive to the query, and provide to the device 510 information to display a list of search results for the responsive documents. In examples where a verbal query is received, the voice recognition service 572 may translate the received audio into a textual query that is sent to the search engine.

These and other services may be implemented in a server system 590. A server system may be a combination of hardware and software that provides a service or a set of services. For example, a set of physically separate and networked computerized devices may operate together as a logical server system unit to handle the operations necessary to offer a service to hundreds of individual computing devices.

In various implementations, operations that are performed “in response” to another operation (e.g., a determination or an identification) are not performed if the prior operation is unsuccessful (e.g., if the determination was not performed). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

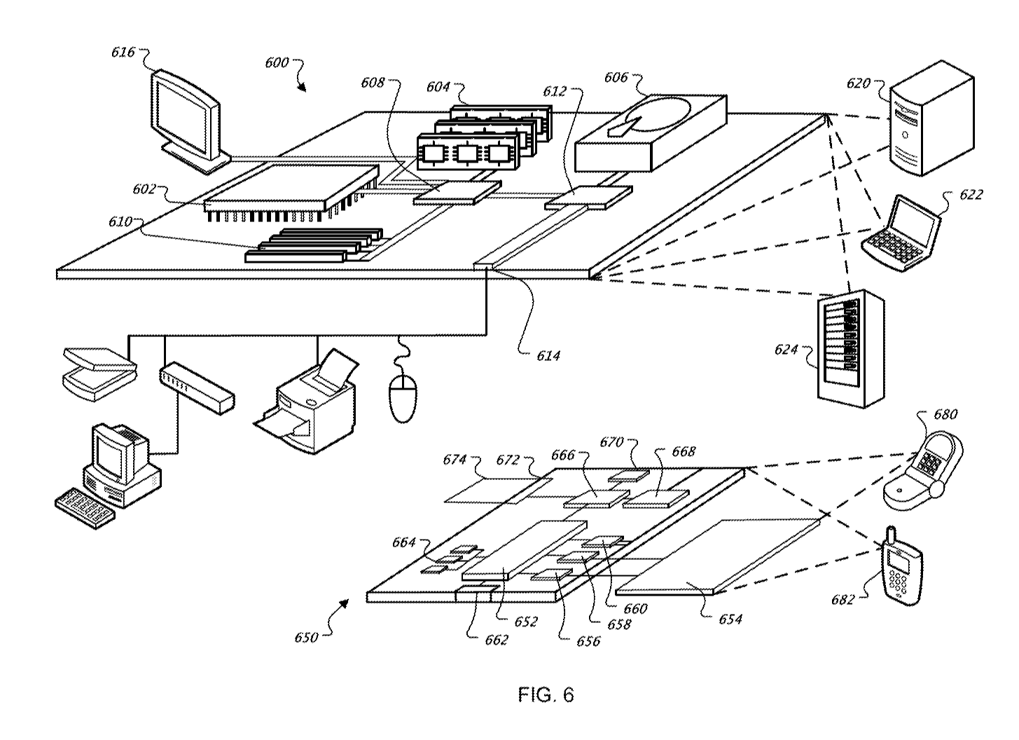

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. Additionally computing device 600 or 650 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652 that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method for providing an interactive display of predictive weather data, the method comprising:
accessing a data set of predictive atmospheric temperature values for a time period, and a data set of predictive values of a second weather statistic for the time period;
displaying, by a computing device and on a display device, a graphical interface that includes:
(i) a graph with the data set of predictive atmospheric temperature values plotted to a first axis that corresponds to time and a second axis that corresponds to atmospheric temperature, and with the data set of predictive values for the second weather statistic plotted to the first axis that corresponds to time and a third axis that corresponds to the second weather statistic, the second and third axes being parallel to each other so that a line drawn perpendicular to the second axis intersects the third axis, and
(ii) a numerical display of a predictive atmospheric temperature value for a selected time and a numerical display of a predictive value for the second weather statistic for the selected time; and
receiving, by the computing device, lateral user input over a surface of the display device and the graphical interface, and in response:
(iii) repeatedly changing a position on the graph of a visible indication of the selected time to correspond to the lateral user input, wherein the visible indication of the selected time includes a numerical display of the selected time that repeatedly updates as the position of the visible indication of the selected time changes, and
(iv) repeatedly updating the numerical display of the atmospheric temperature value and the numerical display of the value for the second weather statistic to correspond to the selected time.

2. The method of claim 1, wherein the first axis is an x-axis for the graph and the second and third axes are y-axes for the graph.

3. The method of claim 2, wherein a numerical scale for the second axis is displayed on a first side of the graph and a numerical scale for the third axis is displayed on a second side of the graph that is opposed to the first side of the graph.

4. The method of claim 1, wherein the visible indication comprises a vertical line that intersects the plot for the data set of predictive atmospheric temperature values and the plot for the data set of predictive values for the second weather statistic.

5. The method of claim 1, wherein a plot for the data set of predictive atmospheric temperature values intersects a plot for the data set of predictive values for the second weather statistic.

6. The method of claim 1, wherein the data set of predictive atmospheric temperature values includes a predicted high temperature for the time period.

7. The method of claim 6, wherein the data set of predictive atmospheric temperature values includes a predicted low temperature for the time period.

8. The method of claim 1, wherein a display of a numerical scale for the first axis includes displayed numeric times in the time period, and wherein the times for the time period that are displayed on the numerical scale do not repeatedly change position to correspond to the lateral user input that is received over the surface of the display device.

9. The method of claim 1, wherein the second weather statistic includes predictive likelihood of precipitation.

10. The method of claim 1, wherein the second weather statistic includes predictive humidity.

11. The method of claim 1, wherein the graphical interface further comprises one or more numerical displays of an additional weather statistic that repeatedly updates to correspond to the selected time.

12. The method of claim 11, wherein one of the displayed additional weather statistics includes wind velocity and direction.

13. The method of claim 11, wherein one of the displayed additional weather statistics includes a textual description of a state of weather.

14. The method of claim 13, wherein the textual description of a state of weather includes text selected from the group consisting of: sunny, sun, cloudy, clouds, overcast, rainy, rain, raining, stormy, storm, storming, thunderstorm, snow, snowy, snowing, ice, icy, hail, haling, sleet, and sleeting.

15. The method of claim 1, wherein a numerical scale for the second axis and a numerical scale for the third axis are displayed, but a line running lengthwise along the second axis and a line running lengthwise along the third axis are not displayed.

16. The method of claim 1, wherein the second axis and the third axis are overlapping axes.

17. The method of claim 1, wherein the operations further comprise determining the time period by: (a) identifying a present time, and (b) determining the predetermined time period as a time period that includes the present time and time before and after the present time.

18. A computer-readable storage medium storing instructions that, when executed by one or more processing devices, perform operations for providing an interactive display of predictive weather data, the operations comprising:
accessing a data set of predictive atmospheric temperature values for a time period, and a data set of predictive values of a second weather statistic for the time period;
displaying, by the computing device and on a display device, a graphical interface that includes:
(i) a graph that includes a plot of the data set of predictive atmospheric temperature values that intersects a plot of the data set of the second weather statistic, the graph having a first axis that corresponds to time and one or more other axes that correspond to atmospheric temperature and the second weather statistic, and
(ii) a numerical display of a predictive atmospheric temperature value for a selected time and a numerical display of a predictive value for the second weather statistic for the selected time; and
receiving, by the computing device, a user input that transitions across a display of the graphical interface and in response:
(iii) repeatedly changing a position on the graph of a visible indication of the selected time as the user input transitions across the display, wherein the visible indication includes a numerical display of the selected time that repeatedly updates to be consistent with a time that corresponds to the position of the visible indication of the selected time, and
(iv) repeatedly updating the numerical display of the atmospheric temperature value and the numerical display of the value for the second weather statistic to correspond to the selected time as the user input transitions across the display.

19. A method for providing an interactive display of weather data, the method comprising:
accessing a data set of atmospheric temperature values, and a data set of values of a second weather statistic;
displaying, by a computing device and on a display, a graphical interface that includes:
(i) a graph that includes a plot of the data set of atmospheric temperature values that overlaps with a plot of the data set of the second weather statistic, and
(ii) a numerical display of an atmospheric temperature value for a time selected by a user of the computing device and a numerical display of a value for the second weather statistic for the selected time; and
receiving, by the computing device, a user input that transitions across a display of the graphical interface and in response:
(iii) repeatedly changing, during the transitioning of the user input, a position on the graph of a numerical display of the selected time, wherein the numerical display of the selected time repeatedly changes in time in coordination with the transitioning of the user input, and
(iv) repeatedly updating the numerical display of the atmospheric temperature value and the numerical display of the value for the second weather statistic to correspond to the selected time as the user input transitions across the display, wherein the numerical display of the atmospheric temperature value and the numerical display of the value for the second weather statistic remain in fixed positions during the user input that transitions across the display of the graphical interface.

20. The method of claim 19, wherein the second and third axes are parallel to each other so that a line drawn perpendicular to the second axis intersects the third axis.
